(19) United States
(12) Patent Application Publication
(10) Pub. No.: US 2007/0146406 A1
(43) Pub. Date: Jun. 28, 2007

(54) METHOD FOR MANUFACTURING PATTERNED THIN-FILM LAYER

(75) Inventors: YEN-HUEY HSU, Hsinchu (TW); YU-NING WANG, Hsinchu (TW); CHING-YU CHOU, Hsinchu (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: ICF TECHNOLOGY CO., LTD., Hsinchu (TW)

(21) Appl. No.: 11/309,617

(22) Filed: Sep. 1, 2006

(30) Foreign Application Priority Data
Dec. 23, 2005 (TW) 094146328

(51) Int. Cl. B41J 29/38

(52) U.S. Cl. 347/17

(57) ABSTRACT

A method for manufacturing a patterned thin-film layer includes the steps of: providing a substrate (102) with a plurality of walls (106), the walls cooperatively defining a plurality of spaces (108); depositing ink (110) into the plurality of spaces; controlling a temperature of the substrate so as to increase the viscosity of the ink deposited in the plurality of spaces; and solidifying the ink to form the patterned thin-film layer on the substrate.

### FIELD OF THE INVENTION

The present invention generally relates to a method for manufacturing a patterned thin-film layer on a substrate.

### DESCRIPTION OF RELATED ART

At present, methods for manufacturing a patterned thin-film layer include a photolithographic method and an ink-jet method.

The photolithographic method is described as below: applying a photoresist layer on a substrate; exposing the photoresist layer using a photo mask with a predetermined pattern and developing the exposed photoresist layer to form a predetermined patterned thin-film layer. Thus a large part of the photoresist material is wasted and the efficiency is low. This increases the cost.

The ink-jet method uses an ink-jet device for depositing ink into a predetermined position on a substrate. A patterned thin-film layer is formed after solidifying the ink.

In a conventional ink-jet method, a plurality of walls are formed on the substrate and spaces are defined by the walls. Ink can be deposited into the spaces and solidified to form the patterned thin-film layer. However, when the ink is deposited into the spaces, it is still in a liquid phase and its viscosity is low. After the ink contacts the walls, due to the force driven by surface energy difference between the ink and the walls, the ink climbs up the wall so that the ink near the wall is higher up than the ink in the middle of the space. Therefore, smoothness of resulting patterned layers in the space will not be satisfactory.

What is needed, therefore, is a method for manufacturing a patterned thin-film layer with a satisfactory smoothness.

### SUMMARY OF THE INVENTION

A method for manufacturing a patterned thin-film layer on a substrate according to one preferred embodiment includes the steps of: providing a substrate with a plurality of walls, wherein the walls cooperatively define a plurality of spaces; depositing ink into the plurality of spaces; controlling a temperature of the substrate so as to increase the viscosity of the ink in the plurality of spaces; and solidifying the ink to form the patterned thin film layer on the substrate.

The temperature of the substrate is controlled so as to increase the viscosity of the ink in the plurality of spaces. Therefore, when the ink on the substrate contacts the wall due to the diffusion, it is more difficult for the ink to climb up the wall so that the smoothness of the resulting patterned thin films is satisfactory.

Other advantages and novel features will become more apparent from the following detailed description of the present method, when taken in conjunction with the accompanying drawings.

### BRIEF DESCRIPTION OF THE DRAWINGS

Many aspects of the present method can be better understood with reference to the following drawings. The components in the drawings are not necessarily drawn to scale, the emphasis instead being placed upon clearly illustrating the principles of the present method. Moreover, in the drawings, like reference numerals designate corresponding parts throughout the several views.

FIG. 1 is a flow chart of a method for manufacturing a patterned thin-film layer in accordance with a preferred embodiment;

FIG. 2 is a schematic view of a substrate during a stage of the method of FIG. 1;

FIG. 3 is similar to FIG. 2, but showing a photoresist layer formed on the substrate;

FIG. 4 is similar to FIG. 3, but showing an exposed photoresist layer on the substrate;

FIG. 5 is similar to FIG. 4, but showing a number of spaces defined by the walls on a substrate;

FIG. 6 is similar to FIG. 5, but showing ink deposited into the spaces defined by the walls;

FIG. 7 is similar to FIG. 6, but showing ink layers formed in the spaces on a substrate;

FIG. 8 is similar to FIG. 7, but showing patterned thin films formed in the spaces on a substrate; and

FIG. 9 is similar to FIG. 8, but showing a protective layer covering the walls and the patterned thin films.

Corresponding reference characters indicate corresponding parts throughout the drawings. The exemplifications set out herein illustrate at least one preferred embodiment of the present method, in one form, and such exemplifications are not to be construed as limiting the scope of the invention in any manner.

### DETAILED DESCRIPTION OF THE INVENTION

Reference will now be made to the drawings to describe preferred embodiments of the present method for manufacturing a patterned thin-film layer, in detail.

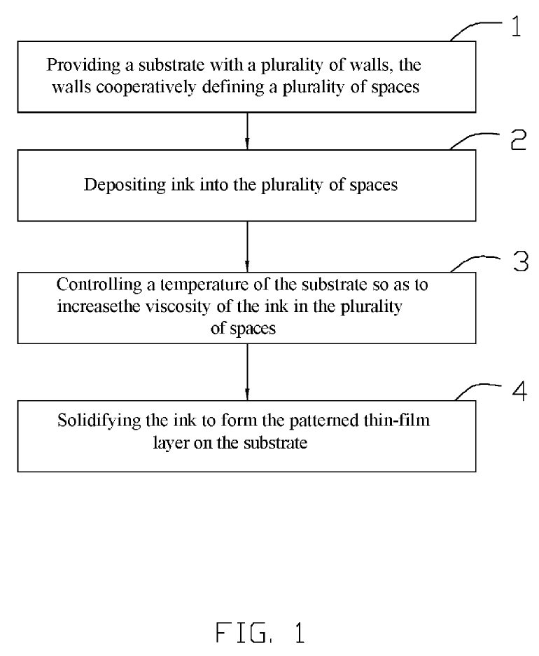

Referring to FIG. 1, a flow chart of a method for manufacturing a patterned thin-film layer on a substrate in accordance with a preferred embodiment is shown. The method mainly includes the steps of: (1) providing a substrate with a plurality of walls, the walls cooperatively defining a plurality of spaces; (2) depositing ink into the plurality of spaces; (3) controlling temperature of the substrate so as to increase the viscosity of the ink in the plurality of spaces; and (4) solidifying the ink to form the patterned thin-film layer on the substrate.

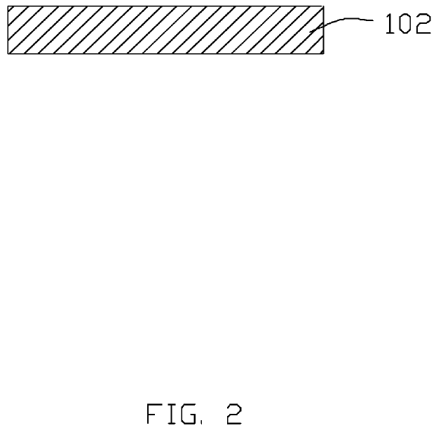

With references of FIGS. 2 to 9, the method is described in more detail.

Referring to FIG. 2, in step (1), a substrate 102 is provided. A material of the substrate 102 is selected from a group consisting of glass, silicon wafer, plastic and metal.

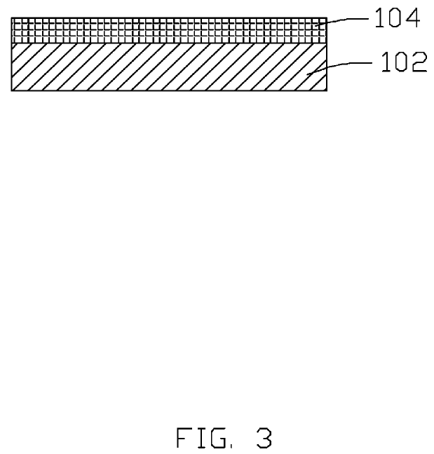

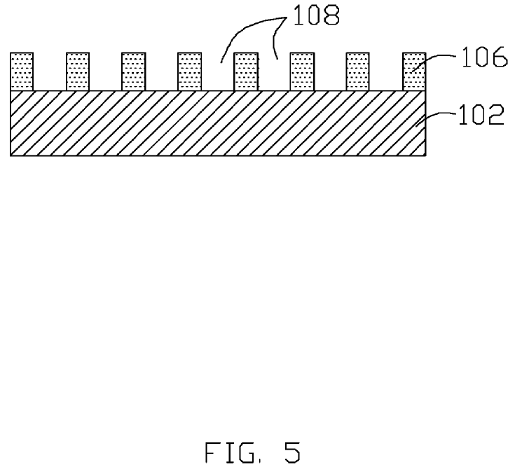

Referring to FIG. 5, a plurality of walls 106 are formed on the substrate 102 and a plurality of spaces 108 are defined by the plurality of walls 106. The plurality of walls 106 may be formed by a photolithography method. Referring to FIGS. 2 to 5, the method for forming the plurality of walls 106 is shown. Referring to FIG. 3, a negative-type photoresist layer 104 is formed on a surface of the substrate 102 by slit coating, spin coating, slit-spin coating or dry film lamination.

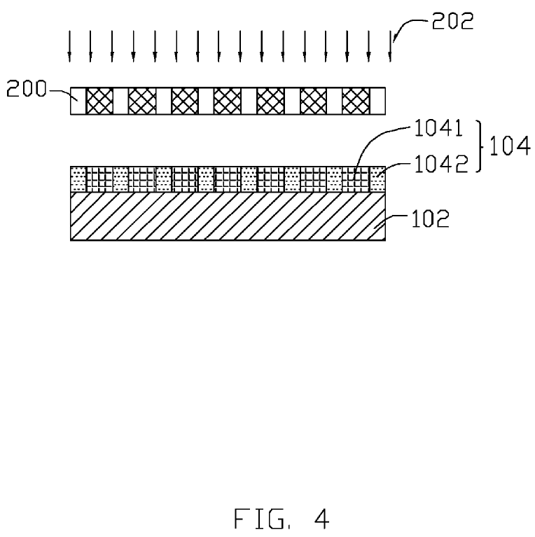

Referring to FIG. 4, the negative-type photoresist layer 104 is exposed using a photo mask 200 disposed between the negative-type photoresist layer 104 and a light-exposure device 202. The light-exposure device may be an ultraviolet light source. The photo mask 200 has a predetermined pattern for the patterned thin-film layer.

Referring to FIGS. 4 and 5, the exposed negative-type photoresist layer 104 is developed to form a patterned photoresist layer serving as the plurality of walls 106. For the negative-type photoresist layer 104, unexposed parts 1041 of the negative-type photoresist layer 104 are removed and the exposed parts 1042 of the negative-type photoresist layer 104 remain after being developed. Therefore, the plurality of walls 106 are formed on the surface of the substrate 102. Besides, alternatively, the photoresist layer 104 can be a positive-type photoresist layer. Correspondingly, exposed parts of the positive-type photoresist layer are removed after being developed.

In addition, the plurality of walls 106 and the substrate 102 may also be integrally molded using an injection molding process. For example, a mold insert with a predetermined pattern of the walls is received into a mold. A molten material of the substrate is injected in the mold. After being cooled, the molded substrate is removed and provided with the plurality of walls.

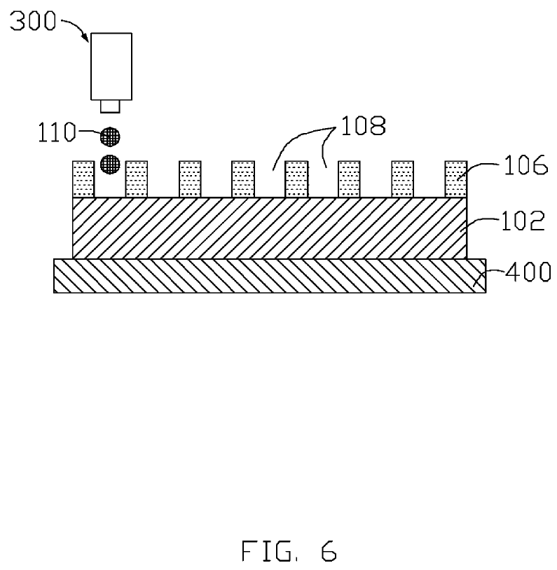

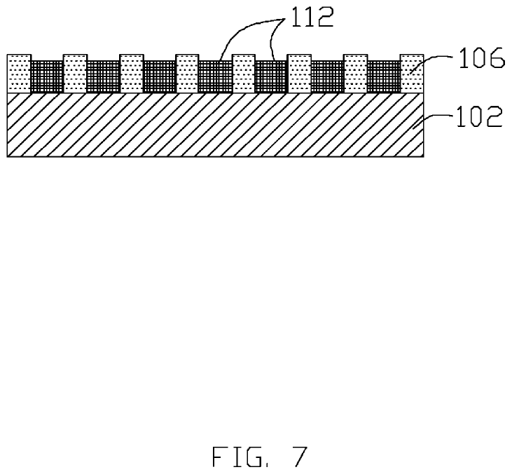

Referring to FIGS. 6 and 7, in step (2), ink 110 containing at least a solvent are deposited by a ink-jet device 300 into each space 108 to form ink layers 112. The ink-jet device 300 is a thermal bubble ink-jet device or a piezoelectrical ink-jet device.

In step (3), a temperature of the substrate 102 is controlled/regulated/adjusted so as to increase the viscosity of the ink in the plurality of spaces. A diffusing speed of the ink 110 is changed as its temperature is changed.

The ink 110 are deposited into the each space 108. For example, when a first ink 110 is deposited into one position of the space 108, the temperature of the substrate 102 is raised up beyond a room temperature, such as 40, 60, 90, or 120 degrees centigrade. The raised temperature can enhance evaporation rate of the solvent contained in the ink 110, therefore when the ink contacts with the substrate 102 in the spaces 108, a viscosity of the ink 110 is increased over, such as 100 centipoise second (cps), preferably over 1000 cps. When a second ink 110 is deposited into another position of the corresponding space 108, the control of the temperature is kept so as to increase the viscosity of the ink 110 in the plurality of spaces 108. Before the ink on the substrate 102 contacts the wall 106 due to the diffusion, the solvent contained in the ink is almost gone so that the viscosity of the ink is high. The ink 110 are then transformed into ink layers 112 in each space 108.

Referring to FIG. 6 again, the raised temperature of the substrate 102 is controlled by a heating device 400 with a heating surface, such as a metallic hot-plate. The substrate 102 is placed on the heating surface of the heating device 400. Besides the heating way to control the temperature of the substrate 102, other methods may be used, such as a cooling way, to control the temperature of the substrate 102 lower than the temperature of the ink 110 before being deposited into the space 108. By doing so, the viscosity of the ink will raise, too.

The substrate 102 moves relatively to the ink-jet device 300 so as to finish depositing the ink 110 into the spaces 108 defined by the plurality of walls 106.

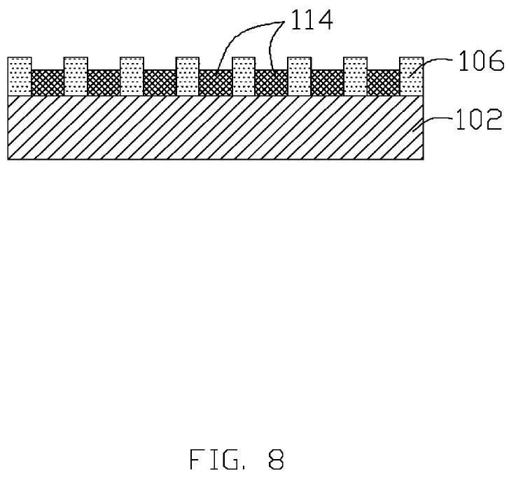

Referring to FIGS. 7 and 8, in step (4), the ink layers 112 are solidified by a solidifying device (not shown), such as a heating device or a light-exposure device, to form patterned thin films 114. The light-exposure device is generally an ultraviolet light source. A heating device and a vacuum-pumping device can also be used for solidifying the ink layers 112 in the spaces 108 defined by the plurality of walls 106.

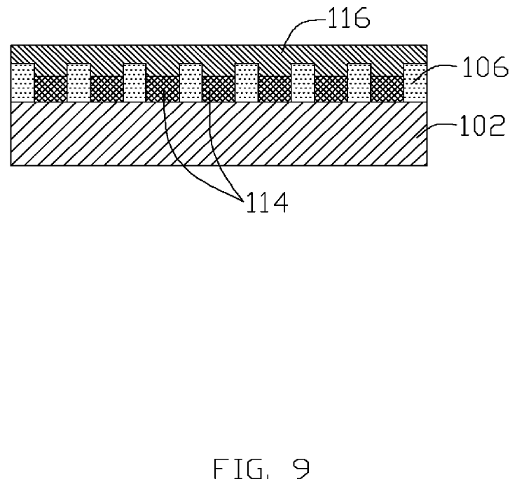

Referring to FIG. 9, an addition step following the step (4) for forming a protective layer 116 may be performed. The protective layer 116 is overcoated so as to cover the plurality of walls 106 and the patterned thin films 114 for better properties, such as protection against humidity, pollution-resistance, oxidation-proof and a smoothness of the patterned thin films 114. A material of the protective layer 116 is selected from a group consisting of polyimide resin, epoxy resin, acrylic resin and polyvinyl alcohol resin.

When the ink 110 are deposited into the spaces 108, the temperature of the substrate 102 is controlled so as to increase the viscosity of the ink in the plurality of spaces 108. Therefore, when contacting the wall 106, the ink in the plurality of spaces 108 has difficulty in climbing up the wall 106 so that smoothness of the resulting patterned thin films 114 is satisfactory.

The method in accordance with the preferred embodiment can be used in manufacturing items such as color filters or organic light-emitting diodes. In manufacturing a color filter, the patterned thin films can be three-primary-color colored layers. In manufacturing an organic light-emitting diode, the patterned thin films can be conductive layers, light-emitting layers, electron-transmission layers or hole-transmission layers.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A method for manufacturing a patterned thin-film layer on a substrate, comprising the steps of:
providing a substrate with a plurality of walls, the walls cooperatively defining a plurality of spaces;
depositing ink into the plurality of spaces;
controlling a temperature of the substrate so as to increase the viscosity of the ink in the plurality of spaces; and
solidifying the ink to form the patterned thin-film layer on the substrate.

2. The method of claim 1, wherein the plurality of walls and the substrate are integrally formed by an injection molding process.

3. The method of claim 1, wherein the plurality of walls are formed by a method comprising the steps of:
forming a photoresist layer on the substrate;
exposing the photoresist layer; and
developing the photoresist layer to form a patterned photoresist layer serving as the plurality of walls.

4. The method of claim 3, wherein the photoresist layer is formed on the substrate by slit coating, spin coating, slit-spin coating or dry film lamination.

5. The method of claim 3, wherein the photoresist layer is exposed using a mask with a pattern.

6. The method of claim 1, wherein the ink is deposited using an ink-jet device.

7. The method of claim 6, wherein the ink-jet device is a thermal bubble ink-jet device or a piezoelectrical ink-jet device.

8. The method for manufacturing a patterned thin-film layer of claim 1, wherein the temperature of the substrate is controlled by a heating device.

9. The method of claim 8, wherein the temperature of the substrate is controlled in a range from 40 to 120 degrees centigrade.

10. The method of claim 1, wherein the ink is solidified by a heating device or a light-exposure device.

11. The method of claim 10, wherein the light-exposure device is an ultraviolet light source.

12. The method of claim 1, wherein the ink is solidified using a heating device and a vacuum-pumping device.

13. The method of claim 1, wherein the viscosity of the ink contacting with the substrate in the plurality of spaces is more than 100 centipoise second.

14. The method of claim 1, wherein the substrate is comprised of a material selected from a group consisting of glass, silicon, plastic and metal.

15. The method of claim 1, further comprising a step of: forming a protective layer on the plurality of walls and the patterned thin film layer thereby covering the plurality of walls and the patterned thin film layer.

16. The method of claim 15, wherein a material of the protective layer is selected from a group consisting of polyimide resin, epoxy resin, acrylic resin and polyvinyl alcohol resin.

17. The method of claim 1, wherein the step of depositing ink and the step of controlling a temperature of the substrate are performed simultaneously.

18. The method of claim 1, wherein the ink contains at least a solvent.

19. A method for manufacturing a patterned thin-film layer on a substrate, comprising the steps of:
providing a substrate with a plurality of recesses;
depositing ink into the plurality of recesses;
controlling a temperature of the substrate so as to increase the viscosity of the ink in the plurality of recesses; and
solidifying the ink to form the patterned thin-film layer on the substrate.

20. The method of claim 19, wherein the step of depositing ink and the step of controlling a temperature of the substrate are performed simultaneously.

21. The method of claim 19, wherein the ink contains at least a solvent.
